(19) United States
(12) Patent Application Publication
(10) Pub. No.: US 2026/0358235 A1
(43) Pub. Date: Nov. 12, 2026

(54) ROCKET EXHAUST EXPOSURE SIMULATION SYSTEM

(71) Applicant: Southwest Research Institute, San Antonio, TX (US)

(72) Inventors: Matthew S. BLAIS, Lake Hills, TX (US); Isaac Alexander R. ANCHONDO, San Antonio, TX (US); Thomas L. HOLLINGSWORTH, Schertz, TX (US)

(21) Appl. No.: 19/205,551

(22) Filed: May 12, 2025

(51) Int. Cl. G01N 17/00; F02K 9/08; C06B 29/22; C06B 33/00; C06B 45/10

(52) U.S. Cl. CPC G01N 17/00; F02K 9/08; C06B 29/22; C06B 33/00; C06B 45/10

(57) ABSTRACT

A rocket exhaust exposure simulation system, a rocket exhaust exposure simulator, and a method of simulating rocket fuel exhaust. The system provides for the ability to simulate rocket exhaust exposure to test suitability of materials for their use as launch surfaces.

### GOVERNMENT SUPPORT CLAUSE

This invention was made with United States Government support under Contract No. N0002419C2322, from the U.S. Navy. The Government has certain rights in this invention.

### FIELD

The present disclosure is directed to a rocket exhaust exposure simulation system, a rocket exhaust exposure simulator, and a method of simulating rocket exhaust exposure.

### BACKGROUND

Exhaust flow from a rocket motor can flow at approximately 3500 feet per second, have temperatures of approximately 2400° C, and contain aluminum oxide particles and hydrogen chloride (HCl) gas. These conditions can have catastrophic effects on surfaces that are exposed to rocket motor exhaust (i.e., launch surfaces) such as a launch pads, ship decks, etc. It is important, when designing/selecting material for a launch surface, to understand what kind of deterioration each material will experience under these launch conditions. Actual rocket launches are expensive and impractical means of testing launch surface materials, especially where multiple tests are desired. Thus, there exists a need for a means of simulating rocket exhaust exposure to test suitability of materials for their use as launch surfaces.

### SUMMARY

A rocket exhaust exposure simulation system, comprising: a rocket exhaust exposure simulator, including a cylinder having an internal volume enclosed by a circumferential wall, a front cylinder flange and a rear cylinder flange, the front cylinder flange having an opening in fluid communication with the internal volume, the front cylinder further having a front flange track configured to secure an outlet plate to the cylinder. The outlet plate comprises a backing plate having an opening, and an outlet duct attached to the backing plate such that the outlet duct is fluidly connected with the opening in the backing plate. A rocket fuel charge comprising rocket fuel is positioned on the rear cylinder flange such that all or a portion of the rocket fuel faces the opening in the front cylinder flange. The system further includes a sample stand comprising a sample mounted to a stand support wherein the outlet duct is directed at the sample material.

A rocket exhaust exposure simulator comprising a cylinder having an internal volume enclosed by a circumferential wall, a front cylinder flange and a rear cylinder flange, the front cylinder flange having an opening in fluid communication with the internal volume, the front cylinder further having a front flange track configured to secure an outlet plate to the cylinder. The outlet plate comprises a backing plate having an opening, and an outlet duct attached to the backing plate such that the outlet duct is fluidly connected with the opening in the backing plate.

A method of simulating rocket exhaust exposure, comprising providing a rocket exhaust exposure simulator comprising a cylinder having an internal volume enclosed by a circumferential wall, a front cylinder flange and a rear cylinder flange, the front cylinder flange having an opening in fluid communication with the internal volume, the front cylinder further having a front flange track configured to secure an outlet plate to the cylinder wherein the outlet plate comprises a backing plate having an opening, and an outlet duct attached to the backing plate such that the outlet duct is fluidly connected with the opening in the backing plate. This is followed by positioning a rocket fuel charge comprising rocket fuel on the rear cylinder flange such that all or a portion of the rocket fuel faces the opening in the front cylinder flange and then positioning a fuse having a first end embedded in the rocket fuel and connecting a second end of said fuse to an ignitor outside the rocket exhaust exposure simulator. One may then ignite the rocket fuel and direct an exhaust of the rocket fuel towards a sample.

In one embodiment, the rocket fuel preferably has a total weight in the range of 4.0 kilograms to 6.0 kilograms.

In another embodiment, the total weight of the rocket fuel may comprise ammonium perchlorate in the range of 45% to 55% of the total weight of the rocket fuel, aluminum powder in the range of 20% to 30% of the total weight of the rocket fuel, and binder polymer in the range of 20% to 30% of the total weight of the rocket fuel.

In another embodiment, the sample and the rocket fuel within the internal volume of the cylinder may preferably be at a distance from one another in the range of 1 meter to 1.5 meters.

In another embodiment, the fuse may preferably be comprised of a nickel chromium wire coil.

In another embodiment, the backing plate of the outlet plate may have a thickness in the range of 1/8 inch to 5/8 inch.

In another embodiment, the cylinder of the rocket fuel exhaust simulation system may have an external diameter in the range of 28 inches to 32 inches and a wall thickness in the range of 0.4 inches to 0.6 inches.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 depicts a side view of an embodiment of a rocket exhaust exposure simulation system, consistent with the present disclosure.

FIG. 2 depicts a top view of an embodiment of a rocket exhaust exposure simulation system, consistent with the present disclosure.

FIG. 3 depicts a perspective view of an embodiment of a rocket exhaust exposure simulator, consistent with the present disclosure.

FIG. 4 depicts a cross-section of an embodiment of a rocket exhaust exposure simulator, consistent with the present disclosure.

FIG. 5A depicts a front view of an embodiment of an outlet plate, consistent with the present disclosure.

FIG. 5B depicts a side cross-section of an embodiment of an outlet plate, consistent with the present disclosure.

FIG. 6 depicts a photograph of a prototype of an embodiment of a rocket fuel charge, consistent with the present disclosure.

FIG. 7 depicts a photograph of a prototype of an embodiment of a rocket exhaust exposure simulator, consistent with the present disclosure.

FIG. 8 depicts a of a prototype of an embodiment of sample stand, consistent with the present invention.

FIG. 9 depicts a diagram of a method of simulating rocket exhaust exposure, consistent with the present disclosure.

### DETAILED DESCRIPTION

The present disclosure relates to a rocket exhaust exposure simulation system. More specifically, the present disclosure relates to a rocket exhaust exposure simulation system preferably comprising a rocket exhaust exposure simulator and a sample stand.

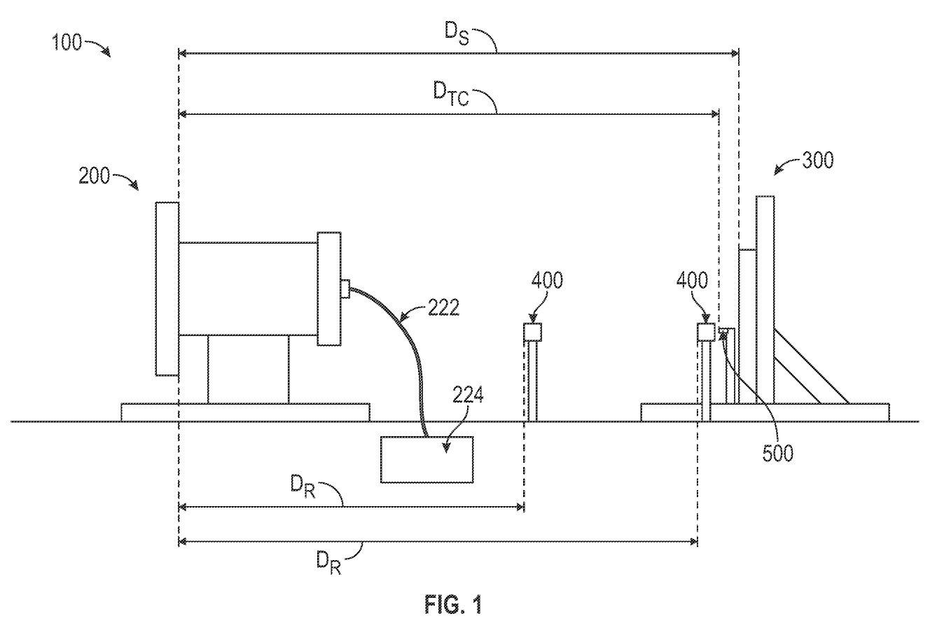

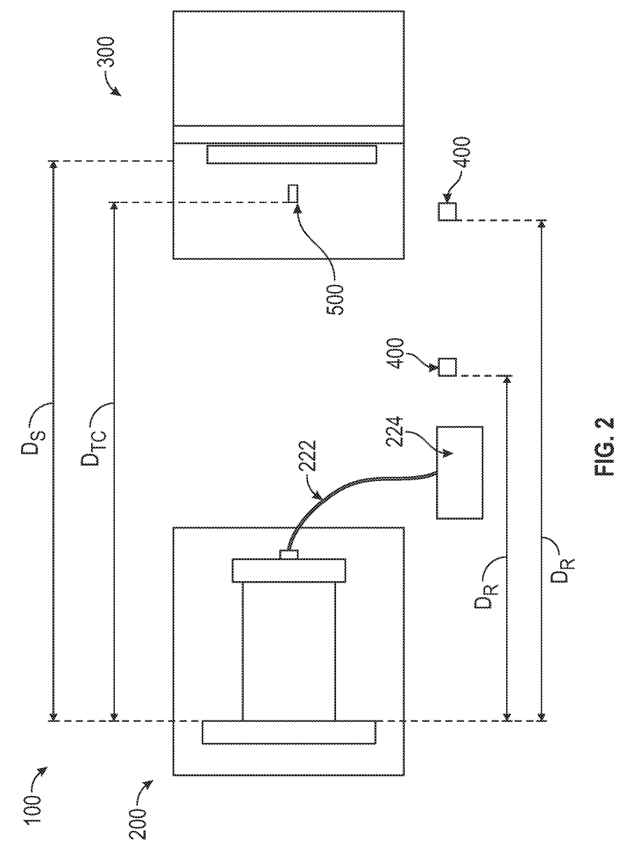

FIG. 1 depicts a side view and FIG. 2 depicts a top view of a preferred embodiment of a rocket exhaust exposure simulation system 100 which may preferably include a rocket exhaust exposure simulator 200 and a sample stand 300.

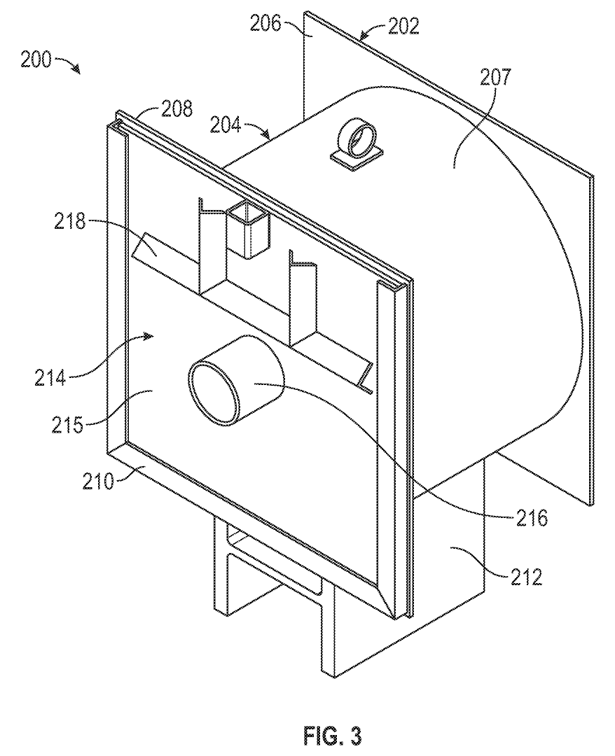

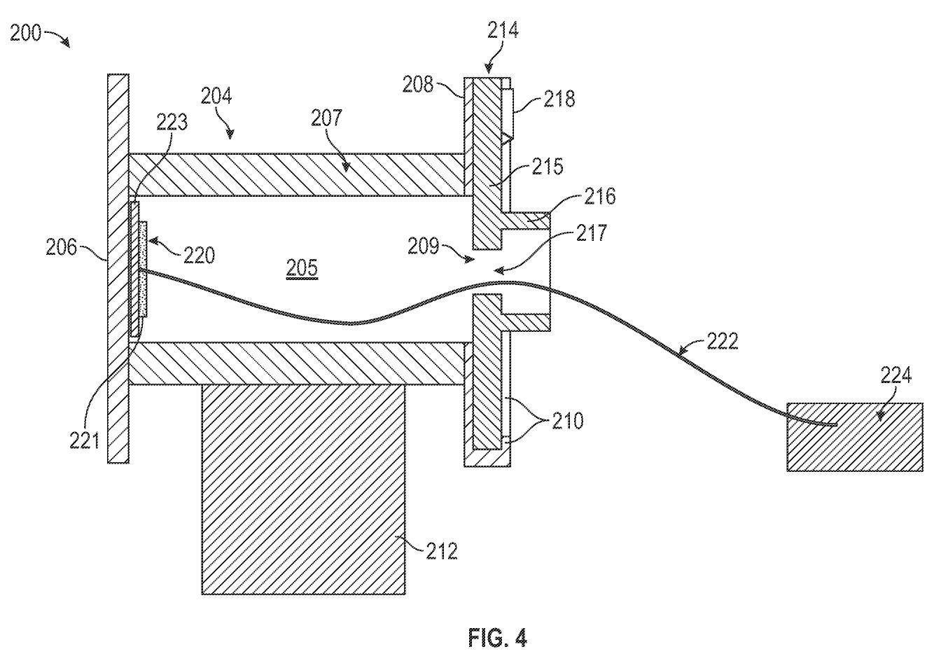

FIGS. 3 and 4 depict an embodiment of the preferred rocket exhaust exposure simulator 200. The rocket exhaust exposure simulator 200 may preferably include an outlet plate 214, a cylinder 204, a rocket fuel charge 220, a fuse 222, and an ignitor 224.

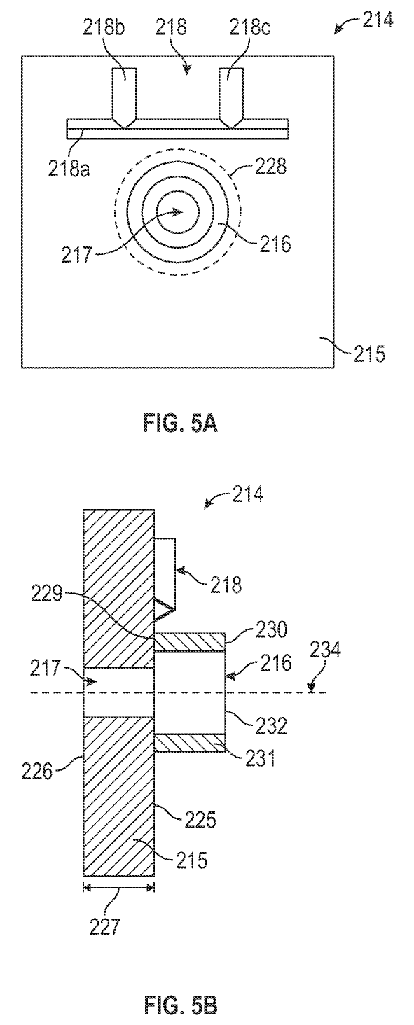

The outlet plate 214, shown in FIGS. 5A and 5B, may preferably include a backing plate 215 and an outlet duct 216. The backing plate 215 may preferably have a front face 225, a back face 226 and a thickness 227 between the front face 225 and back face 226. The backing plate 215 may preferably have a geometry such as, but not limited to, a circle, square, rectangle, triangle, polygon, etc. The backing plate 215 may more preferably be rectangular. The backing plate 215 may preferably be a rectangle having four sides with lengths in the range of 36 inches to 40 inches. The backing plate thickness 227 may preferably be in the range of 1/8 inch to 5/8 inch, more preferably 1/4 inches to 1/2 inch.

The backing plate 215 may preferably include an opening 217. The opening 217 may preferably be located in a central region 228 of the backing plate 215 and extend through the thickness 227 of the backing plate 215. The opening 217 may preferably have a geometry such as but not limited to a circle, oval, square, rectangle, triangle, polygon, etc. The opening 217 may more preferably be circular. The opening 217 may be a circle having a diameter in the range of 2 inches to 4 inches.

The outlet duct 216 may preferably have a wall 231 surrounding an inner channel 232 having a connection end 229 and a free end 230. The wall 231 may preferably have a cross-sectional geometry perpendicular to a longitudinal axis 234 of the outlet duct 216, such as, but not limited to, a circle, oval, square, rectangle, triangle, polygon, etc. The cross-sectional geometry of the wall 231 may more preferably be circular. Further, the cross-sectional geometry of the wall 231 may be a circle having an outer diameter in the range of 4 inches to 8 inches, more preferably in the range of 5 inches to 7 inches. The wall 231 may preferably have a thickness in the range of 0.25 inches to 2.75 inches, more preferably in the range of 1 inch to 2 inches. The distance between the connection end 229 and the free end 230 along the longitudinal axis 234 may preferably be in the range of 4 inches to 8 inches, more preferably 5.5 inches to 6.5 inches.

The outlet duct 216 may preferably be fixed to the backing plate 215. More specifically, the connection end 229 may preferably be fixed to the backing plate’s front face 225. As used herein, fixed may refer to any physical connection between two components, such as, but not limited to welding, mechanically fastening (i.e., bolts, screws, rivets), being molded or cast as a single part, etc. The outlet duct 216 may preferably be fixed to the backing plate 215 such that the longitudinal axis 234 preferably intersects the backing plate opening 217 at a distance in the range of 0 inches to 1 inch from the center of the backing plate opening 217.

The backing plate 215 may preferably include a stiffener 218. The stiffener 218 may preferably comprise on or more beams fixed to the front face 225. The stiffener 218 may preferably be welded to the front face 225. The one or more beams of the stiffener 218 may have a V shaped cross-section where each arm of the V is welded at its end to the front face 225. The stiffener 218, as shown in FIGS. 5A and 5B may preferably comprise three interconnected beams 218a, 218b, 218c where one beam 218a extends horizontally along the front face 225 and two shorter beams 218b, 218c extend vertically from the first beam 218a along the front face 225, approximately equally distanced from the center of the first beam 218a. The first beam 218a may preferably be horizontally centered and located above the opening 217. The first beam 218a may preferably have a horizonal length of approximately 27 inches to 30 inches, more preferably in the range of 28 inches to 29 inches. The two shorter beams 218b, 218c may preferably have a vertical length in the range of 8 inches to 11 inches, more preferably in the range of 9 inches to 10 inches. The two shorter beams 218b, 218c may preferably be fixed to the first beam 218a, more preferably welded to the first beam 218a. The one or more beams of the stiffener 218 may preferably have a peak distance from their connection point to the front face 225 to the apex of their “V” shape in the range of 0.5 inches to 2.5 inches, more preferably 1 inch to 2 inches. The distance between the first beam 218a and the center of the opening 217 may preferably be in the range of 5 inches to 9 inches, more preferably 6.5 inches to 7.5 inches.

The cylinder 204 may preferably have an internal volume 205 enclosed by a circumferential wall 207, a front cylinder flange 208 and a rear cylinder flange 206. The front cylinder flange 208 may preferably have an opening 209 in fluid communication with the internal volume 205.

The front cylinder flange 208 may preferably be fixed to a first end of the circumferential wall 207 and the rear cylinder flange 206 may preferably be fixed to a second end of the circumferential wall 207, the second end of the circumferential wall being opposite the first end of the circumferential wall 207. The front cylinder flange 208 may preferably be fixed to a first end of the circumferential wall 207 such that the opening 209 of the front cylinder flange 208 is intersected by a central longitudinal axis of the cylinder 204.

The circumferential wall 207 may preferably have an external diameter in the range of 28 inches to 32 inches, more preferably in the range of 29.5 inches to 30.5 inches. The thickness of the circumferential wall 207 may preferably be in the range of 0.25 inches to 0.75 inches, more preferably in the range of 0.4 inches to 0.6 inches. The circumferential wall 207 may preferably have a longitudinal length between the first and second ends in the range of 32 inches to 40 inches, more preferably in the range of 35 inches to 37 inches. The opening 209 in the front cylinder flange 208 may preferably have a diameter less than the diameter of the circumferential wall 207 in the range of 1 inch to 5 inches, more preferably in the range of 2 inches to 3 inches. Alternatively, the opening 209 in the front cylinder flange 208 may be flush with the inner diameter of the circumferential wall 207.

The geometries and/or dimensions of the front cylinder flange 208 may be the same or different from those of the rear cylinder flange. The front cylinder flange 208 and the rear cylinder flange 206 may preferably have a geometry, such as, but not limited to, a circle, oval, square, rectangle, triangle, polygon, etc. The front cylinder flange 208 and the rear cylinder flange 206 preferably have a rectangular geometry. More specifically, the front cylinder flange 208 and the rear cylinder flange 206 may preferably have a rectangular geometry having side lengths in the range of 34 inches to 42 inches, more preferably in the range of 37 inches to 39 inches. The front cylinder flange 208 and the rear cylinder flange 206 may preferably have a thickness in the range of 0.1 inches to 2.0 inches, more preferably in the range of 0.25 inches to 1.75 inches.

The front cylinder flange 208 may preferably include a front flange track 210 configured to secure the outlet plate 214 to the cylinder 204. The front flange track 210 may preferably include a lip configured to wrap around an edge of the outlet plate 214. The front flange track 210 may preferably extend over a portion of the front face 225 of the backing plate 215. More preferably, the front flange track 210 may extend over the front face 225 by a distance from the edge of the backing plate 215 in the range of 1 inch to 4 inches, even more preferably in the range of 2 inches to 3 inches. The front flange track 210 may preferably extend around one or more edges of the outlet plate 214 such that the outlet plate 214 may slide in and out of the front flange track 210. For example, where the outlet plate 214 is a rectangle, the front flange track 210 may preferably extend around a bottom edge of the outlet plate 214 and at least a portion of the side edges of the outlet plate 214, leaving the outlet plate 214 able to be removed and inserted at the unobstructed top edge.

The cylinder 204 may preferably be horizontally supported by a stand 212. The stand 212 may preferably support the cylinder 204 such that the central longitudinal axis is above the surface on which stand 212 is resting by a distance in the range of 30 inches to 40 inches, more preferably in the range of 34 inches to 36 inches.

The cylinder 204 – including the circumferential wall 207, front cylinder face 208 and rear cylinder face 206 – the outlet plate 214, and the fuel stand 212 may preferably be comprised of a metal, more preferably a carbon steel.

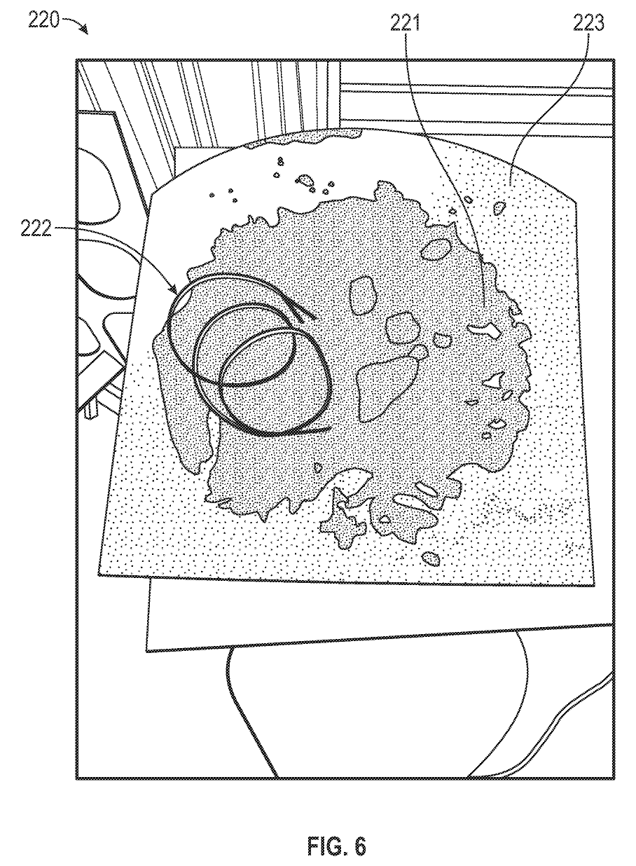

The rocket fuel charge 220, depicted in FIG. 6, may preferably include rocket fuel 221 that is preferably positioned on a board 223. The rocket fuel 221 preferably comprises ammonium perchlorate (AP), aluminum (Al) powder, and a binder polymer (e.g., polyvinyl acrylate or hydroxy-terminated polybutadiene). The rocket fuel 221 may preferably have a total weight in the range of 4.0 kilograms (kg) to 6.0 kilograms (kg), more preferably 4.5 kg to 5.5 kg. One particularly preferred rocket fuel charge falls in the range of 4.9 kg to 5.1 kg. The rocket fuel 221 may preferably comprise AP in the range of 45% to 55% of the total weight of the rocket fuel 221, Al powder in the range of 20% to 30% of the total weight of the rocket fuel 221, and binder polymer in the range of 20% to 30% of the total weight of the rocket fuel 221. The rocket fuel 221 may preferably be a dried mixture and preferably be adhered to the board 223 by nature of the rocket fuel 221 containing binder polymer. Further, the rocket fuel 221 may preferably have a first end of a fuse 222 embedded therein.

The rocket fuel preferably has a surface area in the range of 0.30 meters² to 0.50 meters². One particular preferred surface area for the rocket fuel falls in the range of 0.32 meters² to 0.34 meters². The rocket fuel may preferably have a thickness in the range of 8.5 millimeters to 9.5 millimeters, more preferably 8.9 millimeters to 9.1 millimeters. The board 223 may preferably be comprised of wood, more preferably plywood. The board 223 may preferably have a thickness in the range of 0.2 inches to 0.3 inches, more preferably 0.25 inches. The board 223 may preferably have a geometry such as but not limited to a circle, oval, square, rectangle, triangle, polygon, etc. More preferably, the board 223 may have a geometry of a circle. More specifically, the board 223 may have a geometry of a circle having a diameter in the range of 28 inches to 32 inches, more preferably 30 inches.

The fuse 222 may preferably be a nickel chromium (Ni-Cr) wire coil. The wire coil may preferably have a gauge of in the range of 20 to 24, more preferably 22. More specifically, the fuse 222 may preferably be a wire coil having a diameter in the range of 1 mm to 3 mm, more preferably 2 mm. The fuse 222 may preferably be a wire coil having a quantity of turns in the range of 5 to 7, more preferably 6. The fuse 222 may preferably have a first end and a second end, where the first and second ends are leads extending from the wire coil and having a length in the range of 1 inch to 3 inches, more preferably 2 inches.

The rocket fuel charge 220 may preferably be placed within the internal volume 205 of the cylinder 204. The rocket fuel charge 220 may more specifically be placed within the internal volume 205 of the cylinder 204 and positioned on the rear cylinder flange 206 such that all or a portion of the rocket fuel 221 may face the opening 209 in the front cylinder flange 208. In such manner, the rocket fuel, upon ignition, will be preferably direct its exhaust towards opening 217.

The fuse 222 having the first end embedded in the rocket fuel 221 may preferably exit the cylinder 204 through the front flange opening 209 and extend through the outlet duct 216 of the outlet plate 214. A second end of the fuse 222 may preferably connected to an ignitor 224, where the ignitor 224 is placed outside the rocket exhaust exposure simulator 200.

The ignitor 224 may preferably be a variable transformer configured to provide a continuously adjustable AC voltage. The ignitor 224 may preferably provide a voltage of at least 20 Volts, more preferably at least 40 Volts.

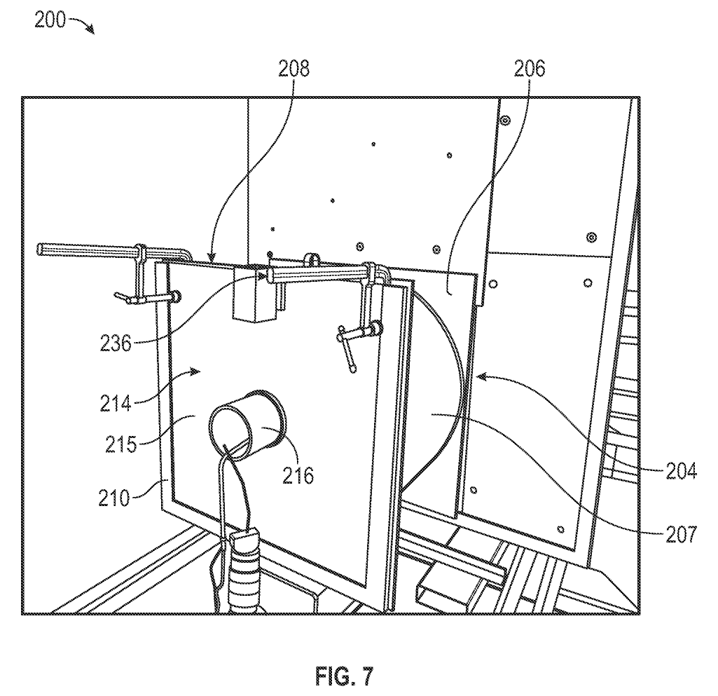

FIG. 7 depicts a prototype of an embodiment of the rocket exhaust exposure simulator 200. The rocket exhaust exposure simulator 200, as shown in FIG. 7 may further include one or more clamping mechanisms 236 configured to secure the outlet plate 214 against the front cylinder flange 208. The clamping mechanisms 236 and the front flange track 210 may preferably secure the outlet plate 214 against the front cylinder flange 208 when the outlet plate 214 is subjected to the forces caused by the ignition of the rocket fuel 221.

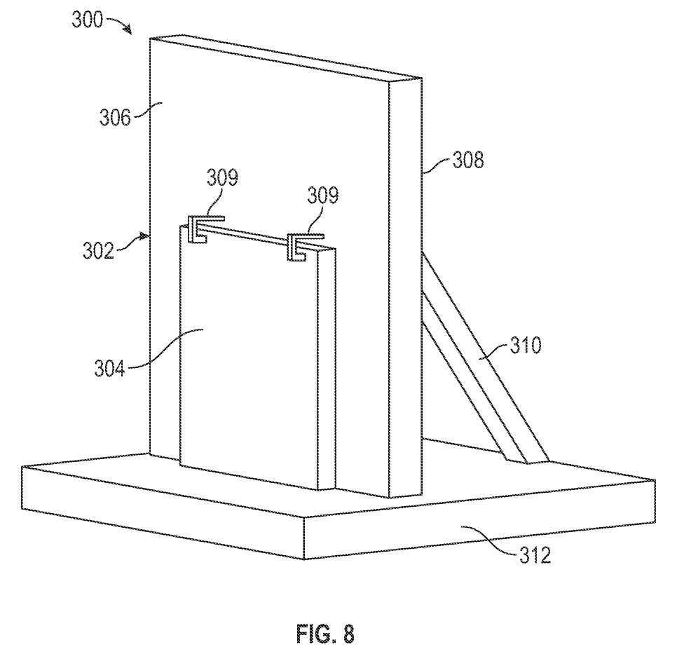

FIG. 8 depicts a prototype of an embodiment of the sample stand 300 configured to support a sample 304. The sample stand 300 preferably includes a sample support 302 having a support face 306 and a braced face 308, the braced face 308 being opposite the support face 306. The support face 306 may preferably provide one or more mounting locations 309 where a sample 304 may be releasably mounted to the support face 306. Releasably mounted refers to a releasable mechanical attachment such as but not limited to clamping, fastening (e.g., bolts, screws, nails), etc. The embodiment shown in FIG. 8 depicts the sample 304 being releasably mounted to the support face 306 by clamping.

The sample support 302 may further include one or more braces 310 fixed to the braced face 308. The one or more braces 310 may preferably also be fixed to a pedestal 312. The pedestal 312 may be, for example, a slab or maybe the floor on which the sample support 302 rests. The sample support 302 may also be fixed directly to the pedestal 312.

As shown in FIGS. 1 and 2, the rocket exhaust exposure simulator 200 and the sample stand 300 may preferably be positioned relative to one another such that the outlet duct 216 of the rocket exhaust exposure simulator 200 is directed at the sample material 304 releasably mounted to the sample stand 300. More specifically, the rocket exhaust exposure simulator 200 and the sample stand 300 may preferably be positioned such that the distance D_{S} between the rocket fuel 221 – which is preferably arranged within the cylinder 204 against the rear cylinder flange 206 – and the sample 304 is in the range of 0.5 meters to 2 meters, more preferably 1 meter to 1.5 meters.

The rocket exhaust exposure simulation system 100 may additionally include one or more sensors. The one or more sensors may preferably include one or more radiometers and/or one or more thermocouples. The embodiment of the rocket exhaust exposure simulation system 100 depicted in FIGS. 1 and 2 includes two radiometers 400 and one thermocouple 500. While this configuration is depicted, it should not be seen as a limitation on the quantity or type of sensors included in the rocket exhaust exposure simulation system 100. For example, the sensors could include one or more of a visual sensor (e.g., camera, infrared, RADAR, LiDAR), temperature sensor (e.g., thermometer, thermistor, thermocouple), pressure sensor, proximity sensor, accelerometer, environmental sensor (i.e., barometer, humidity sensor, etc.), radiometer, etc.

Where the rocket exhaust exposure simulation system 100 includes two radiometers as shown in FIGS. 1 and 2, the radiometers may preferably be positioned at a distance D_{R} from the rocket fuel 221 in the range of 1 meter to 2.5 meters, more preferably 1.5 meters to 2 meters. As shown in FIG. 2, the radiometers may preferably be positioned beyond the edge of the sample stand 300 such that when the rocket exhaust exposure simulator is activated, the radiometers are not in the direct path of the rocket exhaust. On the other hand, the thermocouple 500 may preferably be aligned with the approximate center of the sample 304 (i.e., within a +/- 6 inches of the center) and positioned at a distance D_{TC} from the rocket fuel 221 in the range of 0.5 meters to 2 meters, more preferably 1 meter to 1.5 meters.

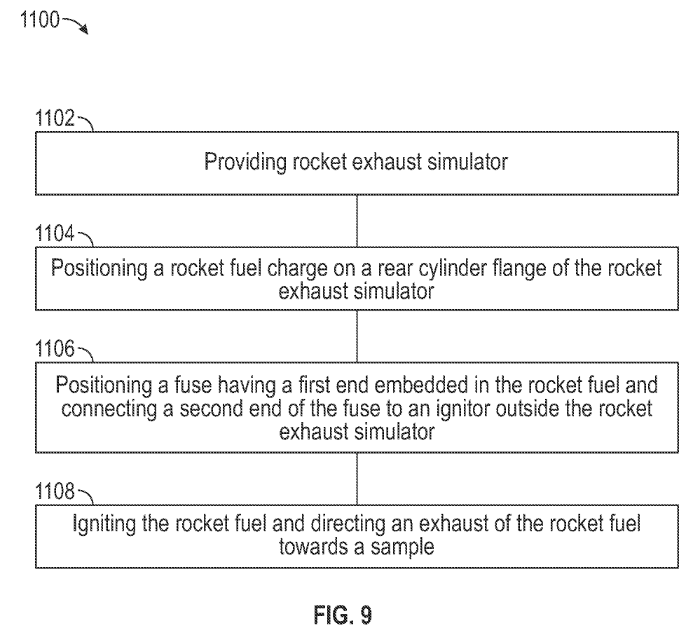

FIG. 9 depicts a method of simulating rocket exhaust exposure 1100 using a rocket exhaust exposure simulation system such as the one described above. The method of simulating rocket exhaust exposure 1100 may preferably includes steps 1102, 1104, 1106, and 1108

Step 1102 includes providing the rocket exhaust simulator as described herein. Step 1104 includes positioning a rocket fuel charge on a rear cylinder flange of the rocket exhaust simulator. Step 1105 includes positioning a fuse having a first end embedded in the rocket fuel and connecting a second end of the fuse outside of the rocket exhaust simulator. This is then followed at step 1106 with igniting the rocket fuel and directing an exhaust of the rocket fuel toward a sample.

The rocket exhaust exposure simulator 200 may preferably provide a burn of the rocket fuel 221 lasting a duration in the range of 1 seconds to 5 seconds, more preferably in the range of 2 seconds to 4 seconds. Further, the energy measured by a radiometer adjacent to the sample stand may preferably measure the rocket exhaust created by the rocket fuel 221 to be in the range of 60 kilowatts/meter² to 70 kilowatts/meter², more preferably in the range of 63 kilowatts/meter² to 65 kilowatts/meter².

What is claimed is:

1. A rocket exhaust exposure simulation system, comprising
a rocket exhaust exposure simulator, comprising,
a cylinder having an internal volume enclosed by a circumferential wall, a front cylinder flange and a rear cylinder flange, the front cylinder flange having an opening in fluid communication with the internal volume, the front cylinder further having a front flange track configured to secure an outlet plate to the cylinder;
the outlet plate comprises a backing plate having an opening, and an outlet duct attached to the backing plate such that the outlet duct is fluidly connected with the opening in the backing plate;
a rocket fuel charge comprising rocket fuel positioned on the rear cylinder flange such that all or a portion of the rocket fuel faces the opening in the front cylinder flange; and
a sample stand comprising a sample mounted to a stand support wherein the outlet duct is directed at the sample material.

2. The rocket exhaust exposure system of claim 1, including a fuse having a first end embedded in the rocket fuel and a second end connected to an ignitor outside the rocket exhaust exposure simulator, the fuse extending through the outlet plate.

3. The rocket fuel exhaust simulation system of claim 1, wherein the rocket fuel comprises a mixture of ammonium perchlorate, aluminum powder and a binder polymer.

4. The rocket fuel exhaust simulation system of claim 3, wherein the rocket fuel has a total weight in the range of 4.0 kilograms to 6.0 kilograms.

5. The rocket fuel exhaust simulation system of claim 4, wherein the total weight of the rocket fuel comprises,
ammonium perchlorate in the range of 45% to 55% of the total weight of the rocket fuel,
aluminum powder in the range of 20% to 30% of the total weight of the rocket fuel, and
binder polymer in the range of 20% to 30% of the total weight of the rocket fuel.

6. The rocket fuel exhaust simulation system of claim 3, wherein the binder polymer is polyvinyl acrylate or hydroxy-terminated polybutadiene.

7. The rocket fuel exhaust simulation system of claim 1, wherein the sample and the rocket fuel within the internal volume of the cylinder are at a distance from one another in the range of 1.0 meter to 1.5 meters.

8. The rocket fuel exhaust simulation system of claim 1, wherein the fuse is comprised of a nickel chromium wire coil.

9. The rocket fuel exhaust simulation system of claim 1, wherein the backing plate of the outlet plate has a thickness in the range of 1/8 inch to 5/8 inch.

10. The rocket fuel exhaust simulation system of claim 1, wherein the cylinder has an external diameter in the range of 28 inches to 32 inches and a wall thickness in the range of 0.4 inches to 0.6 inches.

11. The rocket fuel exhaust simulation system of claim 1, wherein the cylinder has a longitudinal length in the range of 35 inches to 37 inches.

12. The rocket fuel exhaust simulation system of claim 1, wherein the outlet duct has an external diameter in the range of 5 inches to 7 inches and a wall thickness in the range of 1 inch to 2 inches.

13. A rocket exhaust exposure simulator, comprising:
a cylinder having an internal volume enclosed by a circumferential wall, a front cylinder flange and a rear cylinder flange, the front cylinder flange having an opening in fluid communication with the internal volume, the front cylinder further having a front flange track configured to secure an outlet plate to the cylinder;
the outlet plate comprises a backing plate having an opening, and an outlet duct attached to the backing plate such that the outlet duct is fluidly connected with the opening in the backing plate;
a rocket fuel charge comprising rocket fuel positioned on the rear cylinder flange such that all or a portion of the rocket fuel faces the opening in the front cylinder flange.

14. The rocket exhaust exposure simulator of claim 13, including a fuse having a first end embedded in the rocket fuel and a second end connected to an ignitor outside the rocket exhaust exposure simulator, the fuse extending through the outlet plate.

15. The rocket exhaust exposure simulator of claim 13, wherein the rocket fuel comprises a mixture of ammonium perchlorate, aluminum powder and a binder polymer.

16. The rocket exhaust exposure simulator of claim 15, wherein the rocket fuel has a total weight in the range of 4.0 kilograms to 6.0 kilograms.

17. The rocket exhaust exposure simulator of claim 16, wherein the total weight of the rocket fuel comprises,
ammonium perchlorate in the range of 45% to 55% of the total weight of the rocket fuel,
aluminum powder in the range of 20% to 30% of the total weight of the rocket fuel, and
binder polymer in the range of 20% to 30% of the total weight of the rocket fuel.

18. The rocket exhaust exposure simulator of claim 15, wherein the binder polymer is polyvinyl acrylate or hydroxy-terminated polybutadiene.

19. The rocket fuel exhaust exposure simulator of claim 14, wherein the fuse is comprised of a nickel chromium wire coil.

20. The rocket fuel exhaust exposure simulator of claim 13, wherein the backing plate of the outlet plate has a thickness in the range of 1/8 inch to 5/8 inch.

21. The rocket fuel exhaust exposure simulator of claim 13, wherein the cylinder has an external diameter in the range of 28 inches to 32 inches and a wall thickness in the range of 0.4 inches to 0.6 inches.

22. The rocket fuel exhaust exposure simulator of claim 13, wherein the cylinder has a longitudinal length in the range of 35 inches to 37 inches.

23. The rocket fuel exhaust exposure simulator of claim 13, wherein the outlet duct has an external diameter in the range of 5 inches to 7 inches and a wall thickness in the range of 1 inch to 2 inches.

24. A method of simulating rocket exhaust exposure, comprising:
providing a rocket exhaust exposure simulator comprising a cylinder having an internal volume enclosed by a circumferential wall, a front cylinder flange and a rear cylinder flange, the front cylinder flange having an opening in fluid communication with the internal volume, the front cylinder further having a front flange track configured to secure an outlet plate to the cylinder wherein the outlet plate comprises a backing plate having an opening, and an outlet duct attached to the backing plate such that the outlet duct is fluidly connected with the opening in the backing plate;
positioning a rocket fuel charge comprising rocket fuel on the rear cylinder flange such that all or a portion of the rocket fuel faces the opening in the front cylinder flange;
positioning a fuse having a first end embedded in the rocket fuel and connecting a second end of said fuse to an ignitor outside the rocket exhaust exposure simulator; and
igniting said rocket fuel and directing an exhaust of said rocket fuel towards a sample.
